(19) United States
(12) Patent Application Publication
(10) Pub. No.: US 2026/0227054 A1
(43) Pub. Date: Aug. 6, 2026

(54) Luminaire with optical structure

(71) Applicant: SIGNIFY HOLDING B.V., EINDHOVEN (NL)

(72) Inventors: MARC ANDRE DE SAMBER, LOMMEL (BE); NORBERTUS ANTONIUS MARIA SWEEGERS, LIEROP (NL); HUGO JOHAN CORNELISSEN, ESCHAREN (NL)

(21) Appl. No.: 19/147,948

(22) PCT Filed: Jan. 9, 2024
(86) PCT No.: PCT/EP2024/050387

§ 371 Date: Jul. 14, 2025

(30) Foreign Application Priority Data
Jan. 13, 2023 (EP) 23151450.6

(51) Int. Cl. F21V 17/16; F21K 9/62; F21K 9/90; F21V 7/00; F21V 11/02; F21V 17/10; F21Y 105/16

(52) U.S. Cl. CPC F21V 17/16; F21K 9/62; F21K 9/90; F21V 7/0083; F21V 11/02; F21V 17/101; F21Y 2105/16

(57) ABSTRACT

A luminaire (100) and a method (500) for producing a luminaire are provided. The luminaire comprises a light emitting diode, LED, panel (110) comprising a plurality of light emitting diodes (120), LEDs, arranged to emit light (130), and an optical structure (140) arranged on the LED panel and arranged to optically influence the emitted light, whereby the emitted light is arranged to exit the luminaire at least partially via the optical structure, wherein the optical structure comprises a plurality of elements (150), wherein at least one element of the plurality of elements comprises a pointed tip (160) arranged in contact with the LED panel.

### FIELD OF THE INVENTION

The present invention generally relates to luminaires comprising one or more light emitting diodes, LEDs. More specifically, the present invention is related to a luminaire with a LED tile and an optical structure attached and/or fastened to the LED tile.

### BACKGROUND OF THE INVENTION

The use of light emitting diodes (LED) for illumination purposes continues to attract attention. Compared to incandescent lamps, fluorescent lamps, neon tube lamps, etc., LEDs provide numerous advantages such as a longer operational life, a reduced power consumption, and an increased efficiency related to the ratio between light energy and heat energy.

There is currently a large interest and need for lighting arrangements or luminaires which are less complex than present prior art arrangements, in particular regarding the number of components and the effort at assembly. It will be appreciated that there are numerous advantages associated with lighting arrangements or luminaires which are more structurally convenient and non-complex. For example, by using a minimal number of sourced components, the lighting arrangements or luminaires allow for an easy, convenient and/or diverse assembly, dismantling and/or replacement, an improved cost-efficiency, a more conveniently performed customization, etc.

Hence, it is an object of the present invention to combine the advantageous properties of LEDs with the advantageous aspects of a lighting arrangement or luminaire which is convenient and non-complex in its structure.

### SUMMARY OF THE INVENTION

It is of interest to combine the advantageous properties of LEDs with the advantages of a lighting arrangement or luminaire which is convenient and non-complex in its construction or structure.

This and other objects are achieved by providing a luminaire and a method having the features in the independent claim. Preferred embodiments are defined in the dependent claims.

Hence, according to the first aspect of the present invention, there is provided a luminaire.

The luminaire comprises a light emitting diode, LED, panel comprising a plurality of light emitting diodes, LEDs. The LED panel comprises a light diffusing plate, wherein the plurality of LEDs is arranged to emit light towards the light diffusing plate so that, in operation, the LED panel has a homogeneous diffuse light output.

The luminaire further comprises an optical structure arranged on the LED panel.

The optical structure is arranged to optically influence the homogeneous diffuse light output of the LED panel, whereby the homogeneous diffuse light output of the LED panel is arranged to exit the luminaire at least partially via the optical structure.

The optical structure comprises a plurality of elements, wherein at least one element of the plurality of elements comprises a pointed tip arranged in contact with the LED panel to maintain a distance between the optical structure and the light diffusing plate.

According to the second aspect of the present invention, there is provided a method for producing a luminaire.

The method comprises the step of providing a light emitting diode, LED, panel comprising a plurality of light emitting diodes, LEDs, wherein the LED panel comprises a light diffusing plate, and wherein the plurality of LEDs is arranged to emit light towards the light diffusing plate so that, in operation, the LED panel has a homogeneous diffuse light output.

The method further comprises the step of producing an optical structure arranged to optically influence the homogeneous diffuse light output of the LED panel.

The optical structure comprises a plurality of elements, wherein at least one element of the plurality of elements comprises a pointed tip.

The method further comprises the step of mounting the optical structure on the LED panel such that the pointed tip of the at least one element of the plurality of elements comes into contact with the LED panel to maintain a distance between the optical structure and the light diffusing plate.

Thus, the present invention is based on the idea of a luminaire which combines a LED tile and an optical structure. The LED tile and the optical structure of the luminaire are hereby able to achieve a desirable and customized light distribution from the luminaire, whilst the luminaire provides a convenient and cost-efficiently assembly thereof.

The present invention is advantageous in that the optical structure may constitute an “add-on” optical structure, the properties of which may be provided to satisfy the needs or desires of its use, regarding e.g. light distribution, convenience of assembly, aesthetical purposes, etc. For example, the construction, (material) properties, etc., of the optical structure may achieve a customized light distribution of the luminaire. Furthermore, the optical structure may be conveniently attachable to the LED tile, thereby achieving an easy and convenient attachment and/or replacement of the optical structure. Moreover, the optical structure may be aesthetically attractive, leading to an attractive luminaire. Hence, the present invention provides a versatile luminaire concerning many aspects.

The present invention is further advantageous in that the convenience of the luminaire implies a cost-efficient arrangement as such, e.g. concerning the bill of materials. Furthermore, the convenience of the luminaire, notably by the attachment of the optical structure to the LED tile, leads to a cost-efficient assembly thereof.

The present invention is further advantageous in that the optical structure may constitute a single additional (digitally) fabricated component, having numerous advantages such as being cost-efficient, conveniently meeting customer preference(s) and or desire(s), etc. For example, the optical structure in the form of a single additional (digitally) fabricated component may be fabricated locally (e.g., by 3D printing) and/or may be tuned to the needs/customer expectation, thus allowing for a range of diversity of the front plate geometries and front plate appearances of the late stage configuration luminaire.

It will be appreciated that the luminaire of the present invention comprises relatively few components. The relatively low number of components is advantageous in that the luminaire is relatively inexpensive to fabricate. Moreover, the relatively low number of components of the luminaire implies an easier recycling, especially compared to devices or arrangements comprising a relatively high number of components which impede an easy disassembling and/or recycling operation.

The luminaire according to the present invention comprises a light emitting diode, LED, panel comprising a plurality of light emitting diodes, LEDs, arranged to emit light. By the term “LED panel”, it is here meant e.g. a LED tile, a ledinaire, a (ceiling) panel, or the like. Hence, the LED panel is preferably arranged, mounted and/or installed in a ceiling, on a wall, or the like. The luminaire further comprises an optical structure arranged on the LED panel. By “optical structure”, it is here meant substantially any structure, element, unit, arrangement, or the like, which is arranged or configured to optically influence the emitted light such as to guide, to scatter, to refract, or to reflect the emitted light. The emitted light is arranged to exit the luminaire at least partially via the optical structure. In other words, at least a part of the light emitted from the plurality of LEDs exits or is output from the luminaire by passing the optical structure. The optical structure comprises a plurality of elements. At least one element of the plurality of elements comprises a pointed tip arranged in contact with the LED panel. In other words, on or more elements comprises a pointed (sharp) tip by which the element is in contact with the LED panel. By the term “pointed tip”, it is here meant a relatively sharp element protruding from the element. It should be noted that the pointed tip acts as a spacer element to maintain a distance between the element and the LED panel, and thereby between the optical structure and the light diffusing plate of the LED panel, and/or to minimize the contact area between the element and the LED panel.

According to an embodiment of the present invention, the plurality of elements may comprise at least one reflector arranged to reflect at least a part of the emitted light. The present embodiment is advantageous in that the reflector(s) may be arranged or configured to provide a desired lighting distribution of the emitted light from the LED panel.

According to an embodiment of the present invention, the at least one reflector is cup-shaped and extends parallel to a normal, N, of the LED panel, and comprises a first portion, proximal to the LED panel, with a first diameter, d₁, and a second portion, distal to the LED panel, with a second diameter, d₂, wherein d₁>d₂. The present embodiment is advantageous in that the cup-shaped reflector(s) may influence the emitted light from the LED panel in order to achieve a customized lighting distribution. For example, the geometry(ies) of the reflector(s) may be defined by the first diameter, d₁, of the first portion and/or the second diameter, d₂, of the second portion, in order to maximally optimize the efficiency of the luminaire.

According to an embodiment of the present invention, the plurality of elements may comprise at least one lamella arranged to reflect at least a part of the emitted light. Hence, the relatively thin and sharp lamella(s) of the optical structure may reflect the emitted light from the LED panel, whereby a preferred lighting distribution and/or aesthetical appearance of the luminaire and/or emitted light from the luminaire may be achieved.

According to an embodiment of the present invention, the luminaire may further comprise a mixing chamber arranged between the LED panel and the optical structure, wherein the mixing chamber is arranged to mix at least a part of the emitted light. The present embodiment is advantageous in that the mixing chamber may mitigate light losses of the luminaire. More specifically, the mixing chamber is configured to mix the emitted light for a recycling of the light after leaving the LED panel.

According to an embodiment of the present invention, the luminaire may further comprise a foil arranged between the LED panel and the optical structure, wherein the foil is arranged to optically influence at least a part of the emitted light. For example, the foil may be arranged on the LED panel. The present embodiment is advantageous in that the foil improves the light recycling towards the elements of the optical structure. More specifically, the foil may be arranged to collect and direct the emitted light from the LED panel.

According to an embodiment of the present invention, a cross-section of the luminaire parallel to the LED panel may have a rectangular shape, and wherein the plurality of elements of the optical structure is arranged in a matrix configuration. By “matrix configuration”, it is here meant that the plurality of elements is arranged in rows and columns.

According to an example of the present invention, the optical structure may have substantially any geometry, shape, configuration, or the like, which may combine the optical properties thereof with an aesthetical appearance. Regarding the appearance, the optical structure may, for example, mimic spiral(s), elements of nature/nature mimicry (e.g. flowers), nature inspired designs, etc. For any of these optical structure geometries, the optical path from the LED panel to the emission of light from the luminaire is preferably relatively short for a maximal recycling.

According to an embodiment of the present invention, the luminaire may further comprise a fastening mechanism for releasable fastening of the optical structure on the LED panel. Hence, via the fastening mechanism, the optical structure may be (mechanically) attached to the LED panel, and analogously, (mechanically) removed from the LED panel. The present embodiment is advantageous in that the fastening mechanism provides a convenient and efficient fastening of the optical structure to the LED panel, which is particularly suited for a replacement of the optical structure if desired. A reconfiguration and/or change of functionality or aesthetics can thus be achieved on an already installed light panel. Furthermore, it should be noted that in case of replacement of the optical structure, a foil arranged between the LED panel and the optical structure according to a previously described embodiment may optionally be replaced. For example, the (replacement) foil may be configured or designed in such a way that one or more of its properties may be matched with property(ies) of the (replacement) optical structure, such that the recycling of the light is optimized. Also, the replacement of a foil may be conducted by peeling off the foil and then fastening a replacement foil on the LED panel prior to attaching the (replacement) optical structure.

According to an embodiment of the present invention, the fastening mechanism may comprise a snap connection. By “snap connection”, it is here meant any fitting connection such as male connector(s) and correspondingly fitting female connector(s). The present embodiment is advantageous in that the releasable fastening of the optical structure to the LED panel is particularly intuitive, easy and efficient.

According to an embodiment of the present invention, the optical structure may be glued to the LED panel. The present embodiment is advantageous in that the optical structure and the LED panel may be rigidly fastened to each other.

According to an embodiment of the present invention, the optical structure may be produced by one of 3D-printing, injection molding, and thermoforming. The present embodiment is advantageous in that the presented techniques provide an efficient production of the optical structure. The present embodiment is further advantageous in that the optical structure may be fabricated locally (e.g. by 3D-printing) and may be tuned to customer needs, desires and/or expectations. The optical structure may hereby be formed and/or designed with different geometries, appearances, etc.

According to an embodiment of the second aspect of the present invention, the step of mounting the optical structure on the LED panel may comprise releasably fastening the optical structure on the LED panel. The present embodiment is advantageous in that the releasable fastening or attachment of the optical structure on the LED panel facilitates any replacement of optical structures in case of a desire of a change of optical properties of the luminaire, aesthetical appearance, etc. The present embodiment is further advantageous in that the releasable fastening or attachment of the optical structure on the LED panel facilitates any replacement and/or repair of the optical structure is case of damage, tampering, etc. Also, the easy release allows a replacement of the optical structure by a new optical structure that meets new (or future) customer expectations in terms of either functional or aesthetic properties of the ledinaire.

According to an embodiment of the second aspect of the present invention, the step of mounting the optical structure on the LED panel may comprise gluing the optical structure on the LED panel.

Further objectives of, features of, and advantages with, the present invention will become apparent when studying the following detailed disclosure, the drawings and the appended claims. Those skilled in the art will realize that different features of the present invention can be combined to create embodiments other than those described in the following.

### BRIEF DESCRIPTION OF THE DRAWINGS

This and other aspects of the present invention will now be described in more detail, with reference to the appended drawings showing embodiment(s) of the invention.

FIG. 1a schematically shows a luminaire according to an exemplifying embodiment of the present invention,

FIGS. 1b, 2 and 3 schematically show cross-sections of a luminaire according to exemplifying embodiments of the present invention, and

FIG. 4 schematically shows a method for producing a luminaire according to an exemplifying embodiment of the present invention.

### DETAILED DESCRIPTION

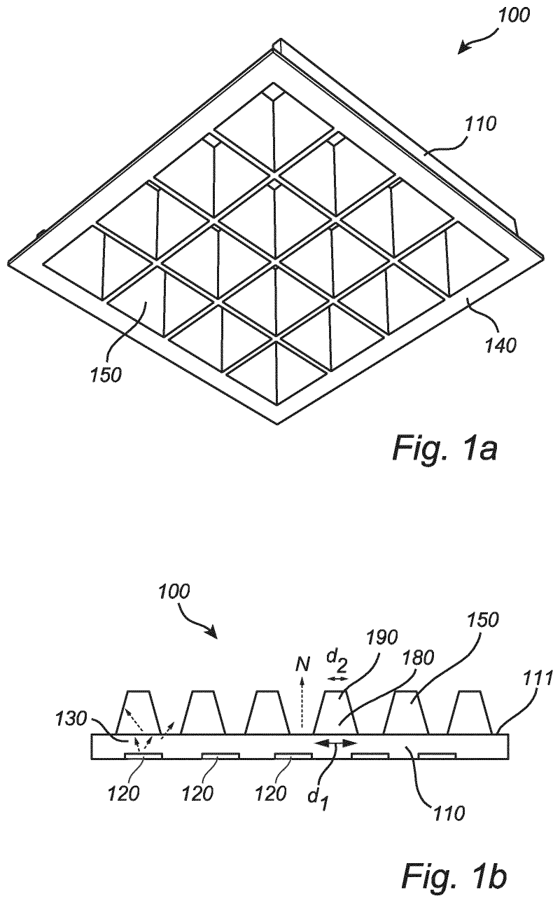

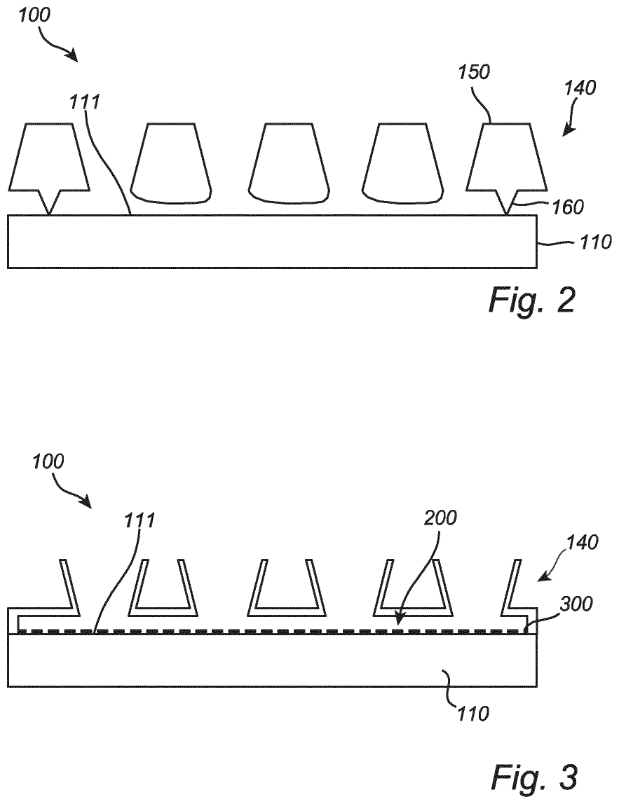

FIG. 1a schematically shows a luminaire 100 according to an exemplifying embodiment of the present invention.

The luminaire 100 comprises a light emitting diode, LED, panel 110 comprising a plurality of light emitting diodes, LEDs 120.

The LED panel 110 is exemplified as having a rectangular (square) shape, but it should be noted that other forms are also feasible.

The LED panel 110 in FIG. 1a is embodied as a LED tile, a ledinaire, a (ceiling) panel, or the like, and the (relatively flat) LED panel 110 may preferably be arranged, mounted and/or installed in a ceiling or on a wall.

The LED panel 110 has a light diffusing plate 111, and the plurality of LEDs 120 is arranged to emit light 130 towards the light diffusing plate 111 so that, in operation, the LED panel has a homogeneous diffuse light output.

The luminaire 100 further comprises an optical structure 140 which is arranged on (attached to) the LED panel 110. The optical structure 140 is arranged to optically influence the homogeneous diffuse light output pf the LED panel 110.

The material of the optical structure 140 may, for example, be polycarbonate.

Analogously with the LED panel 110, the optical structure 140 is also exemplified as having a rectangular (square) shape, albeit other forms are also feasible.

In operation, the LED light 130 emitted from the plurality of LEDs 120 passes through the light diffusing plate 111, thereby creating the diffuse light output of the LED panel 110, which diffuse light output exits the luminaire 100 at least partially via the optical structure 140.

The optical structure 140 comprises a plurality of elements 150. The plurality of elements 150 is arranged in a matrix configuration, exemplified in FIG. 1a as a 4×4 configuration. It should be noted that the optical structure 140 alternatively may have substantially any geometry, shape, configuration, or the like, which may combine the optical properties thereof with an aesthetically appealing appearance. Regarding its appearance, the optical structure 140 may, for example, mimic spiral(s), elements of nature (e.g. flowers), etc.

FIG. 1b schematically shows a cross-section of a luminaire 100 according to an exemplifying embodiment of the present invention and corresponding to the luminaire 100 as shown in FIG. 1a. The plurality of LEDs 120 is arranged to emit light 130 which subsequently passes through the light diffusing plate 111, thereby creating the diffuse light output of the LED panel 110, whereby at least a part of the diffuse light output is arranged to exit the luminaire 100 via the optical structure 140.

The plurality of elements 150 of the luminaire 100 is exemplified as reflectors arranged to reflect at least a part of the emitted light. More specifically, one or more of the reflectors is (are) cup-shaped and extends parallel to a normal, N, of the LED panel 110. The cup-shaped light guiding elements 150 or reflectors comprise a first portion 180, proximal to the LED panel, with a first diameter, d₁, and a second portion 190, distal to the LED panel, with a second diameter, d₂, wherein d₁>d₂.

FIG. 2 schematically shows a cross-section of a luminaire 100 according to an exemplifying embodiment of the present invention and corresponding to the luminaire 100 as shown in FIG. 1a and 1b.

The optical structure 140 of the luminaire 100 comprises a plurality of elements 150, wherein at least one element of the plurality of elements 150 comprises a pointed tip 160 arranged in contact with the LED panel 110 to maintain a distance between the optical structure 140 and the light diffusing plate 111.

In FIG. 2, it is exemplified that the outermost elements 150 each comprises a pointed tip 160, but it should be noted that substantially any configuration of elements 150 which have a respective pointed tip 160 is feasible. It will be appreciated that it is not needed that all elements 150 are in contact with the light diffusing plate 111 of the LED panel 110. The number of elements 150 being in contact with the LED panel (via the pointed tips 160 thereof) may be dependent on the stiffness of the optical structure.

FIG. 3 schematically shows a cross-section of a luminaire 100 according to an exemplifying embodiment of the present invention.

The luminaire 100 comprises a mixing chamber 200 arranged between the LED panel 110 and the optical structure 140. The mixing chamber 200 is arranged to mix at least a part of the emitted light from the plurality of LEDs of the LED panel 110.

The luminaire 100 further comprise a foil 300 which is arranged on the LED panel 110. The foil 300 constitutes the outer layer of the light diffusing plate 111 of the LED panel 110. The foil 300 may, for example, be a brightness enhancement foil (BEF).

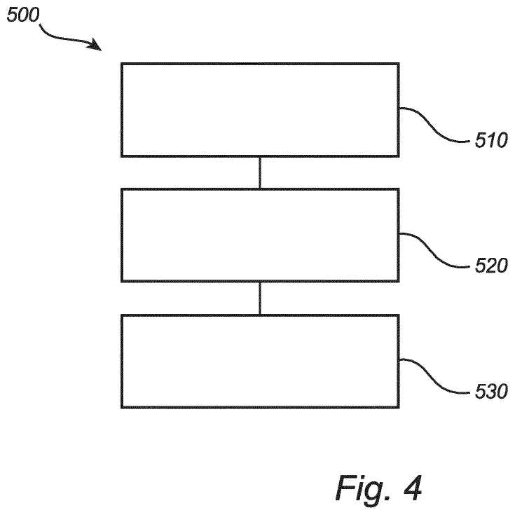

FIG. 4 schematically shows a method 500 for producing a luminaire according to an exemplifying embodiment of the present invention. The method 500 comprises the step of providing 510 a light emitting diode, LED, panel comprising a plurality of light emitting diodes, LEDs, arranged to emit light. The method 500 further comprises the step of producing 520 an optical structure arranged to optically influence the emitted light. The optical structure comprises a plurality of elements, wherein at least one element of the plurality of elements comprises a pointed tip. The step of producing 520 the optical structure may comprise 3D-printing, injection molding, or thermoforming. The method 500 further comprises the step of mounting 530 the optical structure on the LED panel such that the pointed tip of the at least one element of the plurality of elements comes into contact with the LED panel. The step of mounting 530 the optical structure on the LED panel may comprise releasably fastening the optical structure on the LED panel, e.g. via a snap connection. Alternatively, the step of mounting 530 the optical structure on the LED panel may comprise gluing the optical structure on the LED panel. Optionally, before the step of mounting 530 the optical structure on the LED panel, a (light-recycling) foil may be applied 525.

The person skilled in the art realizes that the present invention by no means is limited to the preferred embodiments described above. On the contrary, many modifications and variations are possible within the scope of the appended claims. For example, one or more of the LED panel 110, the optical structure 140, the elements 150, the mixing chamber 200, etc., may have different shapes, dimensions and/or sizes than those depicted/described.

1. A luminaire comprising a light emitting diode, LED, panel comprising a plurality of light emitting diodes, LEDs,
wherein the LED panel comprises a light diffusing plate,
wherein the plurality of LEDs is arranged to emit light towards the light diffusing plate so that, in operation, the LED panel has a homogeneous diffuse light output,
wherein the luminaire further comprises an optical structure arranged on the LED panel,
wherein the optical structure is arranged to optically influence the homogeneous diffuse light output of the LED panel, whereby the homogeneous diffuse light output of the LED panel is arranged to exit the luminaire at least partially via the optical structure,
wherein the optical structure comprises a plurality of elements, and
wherein at least one element of the plurality of elements comprises a pointed tip arranged in contact with the LED panel to maintain a distance between the optical structure and the light diffusing plate.

2. The luminaire according to claim 1, wherein the plurality of elements comprises at least one reflector arranged to reflect at least a part of the emitted light.

3. The luminaire according to claim 2, wherein the at least one reflector is cup-shaped and extends parallel to a normal, N, of the LED panel, and comprises:
a first portion, proximal to the LED panel, with a first diameter, d₁, and
a second portion, distal to the LED panel, with a second diameter, d₂, wherein d₁>d₂.

4. The luminaire according to claim 1, wherein the plurality of elements comprises at least one lamella arranged to reflect at least a part of the emitted light.

5. The luminaire according to claim 1, further comprising:
a mixing chamber arranged between the LED panel and the optical structure, wherein the mixing chamber is arranged to mix at least a part of the emitted light.

6. The luminaire according to claim 1, further comprising:
a foil arranged between the LED panel and the optical structure, wherein the foil is arranged to optically influence at least a part of the emitted light.

7. The luminaire according to claim 1, wherein a cross-section of the luminaire parallel to the LED panel has a rectangular shape, and wherein the plurality of elements of the optical structure is arranged in a matrix configuration.

8. The luminaire according to claim 1, further comprising a fastening mechanism for releasable fastening of the optical structure on the LED panel.

9. The luminaire according to claim 8, wherein the fastening mechanism comprises a snap connection.

10. The luminaire according to claim 1, wherein the optical structure is glued to the LED panel.

11. The luminaire according to claim 1, wherein the optical structure is produced by one of:
3D-printing,
injection molding, and
thermoforming.

12. A method for producing a luminaire, comprising the steps of:
providing a light emitting diode, LED, panel comprising a plurality of light emitting diodes, LEDs, wherein the LED panel comprises a light diffusing plate, and wherein the plurality of LEDs is arranged to emit light towards the light diffusing plate so that, in operation, the LED panel has a homogeneous diffuse light output,
producing an optical structure arranged to optically influence the homogeneous diffuse light output of the LED panel, the optical structure comprising a plurality of elements, wherein at least one element of the plurality of elements comprises a pointed tip, and
mounting the optical structure on the LED panel such that the pointed tip of the at least one element of the plurality of elements comes into contact with the LED panel to maintain a distance between the optical structure and the light diffusing plate.

13. The method according to claim 12, wherein the step of producing the optical structure comprises one of:
3D-printing,
injection molding, and
thermoforming.

14. The method according to claim 12, or wherein the step of mounting the optical structure on the LED panel comprises releasably fastening the optical structure on the LED panel.

15. The method according to claim 12, or wherein the step of mounting the optical structure on the LED panel comprises gluing the optical structure on the LED panel.
